(19) United States
(12) Patent Application Publication
(10) Pub. No.: US 2013/0054473 A1
(43) Pub. Date: Feb. 28, 2013

(54) Secure Payment Method, Mobile Device and Secure Payment System

(71) Applicants: Ren-Jung Jan, Taoyuan City (TW); Chang-Cheng Su, Taoyuan City (TW); Hung-Wen Chien, Taoyuan City (TW); Hsin-Ti Chueh, Taoyuan City (TW)

(72) Inventors: Ren-Jung Jan, Taoyuan City (TW); Chang-Cheng Su, Taoyuan City (TW); Hung-Wen Chien, Taoyuan City (TW); Hsin-Ti Chueh, Taoyuan City (TW)

(73) Assignee: HTC CORPORATION, Taoyuan City (TW)

(21) Appl. No.: 13/552,369

(22) Filed: Jul. 18, 2012

Related U.S. Application Data
(60) Provisional application No. 61/526,449, filed on Aug. 23, 2011.

(51) Int. Cl. G06Q 20/40; G06Q 20/32

(52) U.S. Cl. 705/71; 705/64; 705/76

(57) ABSTRACT

The invention discloses a secure payment method, a mobile device and a secure payment system. The secure payment method including steps of: transmitting an encrypted payment request packet from a payment service provider to a mobile device; receiving the encrypted payment request packet by a first operating system running within a normal domain of the mobile device; bypassing the encrypted payment request packet to a second operating system running within a secured domain on the mobile device; decrypting payment request data from the encrypted payment request packet under the secured domain; generating payment response data according to the payment request data under the secured domain; encrypting the payment response data into an encrypted payment response packet under the secured domain; bypassing the encrypted payment response packet to the first operating system under the normal domain; and, transmitting the encrypted payment response packet to the payment service provider.

### RELATED APPLICATIONS

The application claims priority to Provisional Application Ser. No. 61/526,449 filed on Aug. 23, 2011, which is herein incorporated by reference.

### BACKGROUND

1. Technical Field

The present disclosure relates to an electronic commerce system. More particularly, the present disclosure relates to a system, a device and a method with secure payment functionality.

2. Description of Related Art

Recently, electronic commerce (e-commerce) payment systems have become increasingly popular due to the widespread use of the internet-based shopping and banking. Many types of cutting-edge e-commerce payment systems, e.g., credit cards, debit cards, charge cards, digital wallets, e-cashes, mobile payments and e-checks, are newly available for online merchants. Because the wide spreading of on-line mobile devices (e.g., smart phones), the e-commerce payment system based on a mobile device is one of the most popular topics recently.

To achieve a successful e-commerce platform, how to ensure the security of payment data (such as personal identification, payment details, banking information, etc) is a critical issue. Traditionally, a personal code (or password) should be exclusively known between a bank and a client. When the client requests to launch an on-line trading, the bank may verify the identity of client by confirming the personal code.

However, aforesaid traditional verification has some defects. Firstly, when the personal code is long and more secure (e.g., random or changed over time), the personal code may be too complex to be remembered by a user. On the other hand, when the personal code is short and fixed, the personal code may be too easy to be cracked by others. Secondly, after the user enters the personal code on a mobile payment device, the personal code may be stolen or tapped by a hacker or a malicious one, when the mobile payment device is unprotected or the internet connection to the banking platform is unsecured.

### SUMMARY

In order to solve the problems in the art, the disclosure provides a secure payment method, a mobile device and a secure payment system. The mobile device is provided with secure payment functionality, and the secure payment package can be transmitted via a near field communication (NFC). The NFC secure payment procedure can be implemented within a private secure operating system (OS) domain. Unlike conventional payment systems, the NFC secure payment procedure of the invention not only can be used for small bill payment, it further provides user authentication, such as personal identification number (PIN) code, finger print even face recognition to provide better protection of transaction. The authentication input is extracted by the mobile device and later encrypted for secure transmission to the payment service provider. The authentication input can also be processed by the mobile device to confirm user identity before the payment is proceeded with the payment service provider.

An aspect of the invention is to provide a secure payment method including steps of: transmitting an encrypted payment request packet from a payment service provider to a mobile device; receiving the encrypted payment request packet by a first operating system running within a normal domain of the mobile device; bypassing the encrypted payment request packet from the first operating system to a second operating system running within a secured domain on the mobile device; decrypting payment request data from the encrypted payment request packet under the secured domain; generating payment response data according to the payment request data under the secured domain; encrypting the payment response data into an encrypted payment response packet under the secured domain; bypassing the encrypted payment response packet from the second operating system to the first operating system under the normal domain; and, transmitting the encrypted payment response packet to the payment service provider.

According to an embodiment of the invention, the encrypted payment request packet or the encrypted payment response packet is bypassed between the first operating system and the second operating system in a way of storing the encrypted payment request packet or the encrypted payment response packet into a shared memory. The shared memory is accessible to both of the first operating system and the second operating system.

According to an embodiment of the invention, the first operating system is capable of accessing data under the normal domain and denied from accessing data under the secured domain.

According to an embodiment of the invention, the second operating system is capable of accessing data under both of the normal domain and the secured domain.

According to an embodiment of the invention, the second operating system launches a payment application under the secured domain for decrypting the payment request data and encrypting the payment response data according to an encryption key.

According to an embodiment of the invention, the payment service provider includes a backend server. The encryption key is recognized and possessed only by the backend server and the payment application under the secured domain.

According to an embodiment of the invention, the payment request data includes provider identity information. The provider identity information is verified by payment application under the secured domain before generating payment response data.

According to an embodiment of the invention, the payment request data further includes a client identity verification request. The payment response data includes client identity information in response to the client identity verification request. The client identity information is verified by the payment service provider or a backend server of the payment service provider.

According to an embodiment of the invention, the client identity information includes a serial number of the mobile device, a personal identification number or a biometrics characteristic of a user.

Another aspect of the invention is to provide a mobile device including an operating platform, a first operating system, a second operating system, a communication unit and a shared memory. The operating platform has a normal domain and a secured domain. The first operating system runs within a normal domain. The second operating system runs within a secured domain. The communication unit is operated by the first operating system under the normal domain. The communication module is used for receiving an encrypted payment request packet from a payment service provider and transmitting an encrypted payment response packet to the payment service provider. The shared memory is accessible to the first operating system and the second operating system. The encrypted payment request packet and the encrypted payment response packet are bypassed between the first operating system and the second operating system via the shared memory. The payment application is executed by the second operating system. The payment application is used for decrypting payment request data from the encrypted payment request packet, generating payment response data according to the payment request data and encrypting the payment response data into an encrypted payment response packet under the secured domain.

According to an embodiment of the invention, the first operating system is capable of accessing data under the normal domain and denied from accessing data under the secured domain.

According to an embodiment of the invention, the second operating system is capable of accessing data under both of the normal domain and the secured domain.

According to an embodiment of the invention, the payment application decrypts the payment request data and encrypts the payment response data according to an encryption key.

According to an embodiment of the invention, the encryption key is recognized and possessed only by a backend server of the payment service provider and the payment application under the secured domain.

According to an embodiment of the invention, the payment request data includes provider identity information. The provider identity information is verified by payment application under the secured domain before generating payment response data.

According to an embodiment of the invention, the payment request data further includes a client identity verification request. The payment response data includes client identity information in response to the client identity verification request. The client identity information is verified by the payment service provider or a backend server of the payment service provider.

According to an embodiment of the invention, the client identity information includes a serial number of the mobile device, a personal identification number or a biometrics characteristic of a user.

According to an embodiment of the invention, the shared memory is a memory partition allocated in a memory module of the mobile device, and the memory partition is flushed when the payment application is terminated.

Another aspect of the invention is to provide a secure payment system, which includes a payment service provider and a mobile device in aforesaid aspect. The payment service provider includes a near field communication (NFC) transceiver and a backend server. The near field communication (NFC) transceiver is configured for transmitting the encrypted payment request packet to the mobile device and receiving the encrypted payment response packet from the mobile device. The backend server is configured for generating the encrypted payment request packet toward the mobile device and verifying the encrypted payment response packet feedback from the mobile device.

According to an embodiment of the invention, the payment application decrypts the payment request data and encrypts the payment response data according to an encryption key. The encryption key is recognized and possessed only by a backend server of the payment service provider and the payment application under the secured domain.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiments, with reference to the accompanying drawings as follows:

FIG. 1 is a schematic diagram illustrating a secure payment system according to an embodiment of the invention; and

FIG. 2 is a flow chart illustrating a secure payment method according to an embodiment of the invention.

### DESCRIPTION OF THE EMBODIMENTS

In the following description, several specific details are presented to provide a thorough understanding of the embodiments of the present invention. One skilled in the relevant art will recognize, however, that the present invention can be practiced without one or more of the specific details, or in combination with or with other components, etc. In other instances, well-known implementations or operations are not shown or described in detail to avoid obscuring aspects of various embodiments of the present invention.

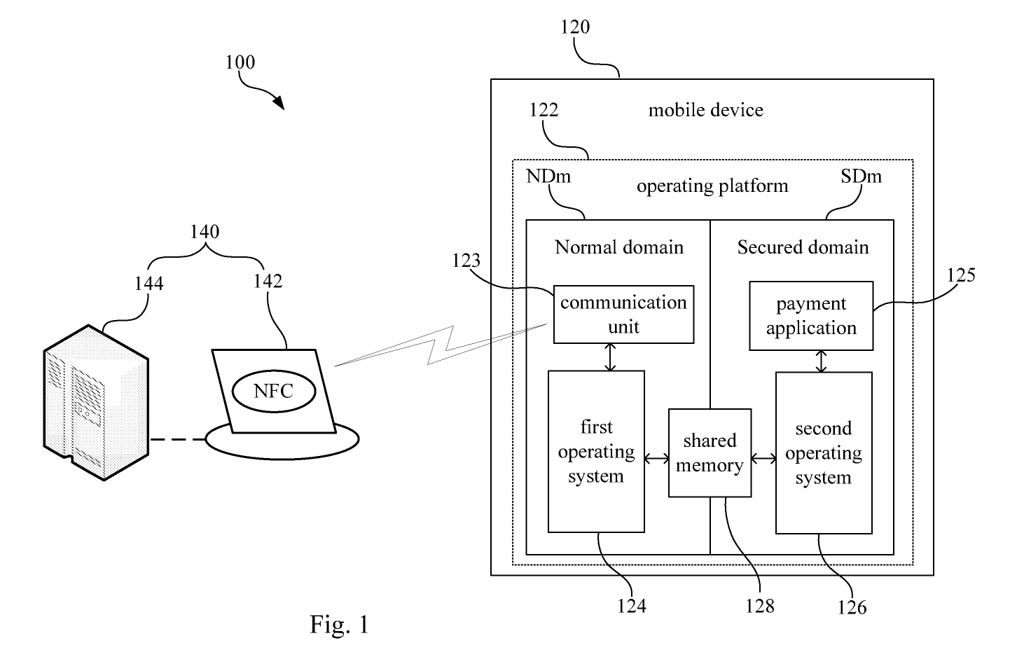

Reference is made to FIG. 1, which is a schematic diagram illustrating a secure payment system 100 according to an embodiment of the invention. In this embodiment, the secure payment system 100 includes a mobile device 120 and a payment service provider 140. For example, the mobile device 120 can be a mobile phone owned by a consumer, and the payment service provider 140 can be electronic machine at the Point Of Sale (POS) owned by business providers (e.g., retailer industry). In this embodiment, the payment service provider 140 includes a near field communication (NFC) transceiver 142 and a backend server 144.

The backend server 144 is configured to generate an encrypted payment request packet, receive a payment response packet, and verify payment data. The backend server 144 can be linked with banking services, credit card/check accounting systems or on-line transaction providing firms. The mobile device 120 is equipped with the ability to communicate with the near field communication (NFC) transceiver 142. The near field communication (NFC) transceiver 142 is configured to transmit the payment information (e.g., payload details of the payment request packet, payment response data, password, PIN code for verification, authorization information, etc) between the backend server 144 and the mobile device 120.

For the safety of the digital payment (e.g., online transaction), the payment request packet should be encrypted first before transmission. The mobile device 120 is configured to receive encrypted data from the near field communication transceiver 142. Then, the mobile device 120 must decrypt the payment request packet and handle the transaction process under a secure environment. Afterward, the mobile device 120 may transmit an encrypted payment response packet back to the near field communication transceiver 142 to complete the transaction. A scope of the invention is about how to establish the secure environment on the mobile device 120 to ensure the safety of the digital payment.

As shown in FIG. 1, there is an operating platform 122 running on the mobile device 120. For example, the operating platform 122 can be a kernel system running on the mobile device 120. In this embodiment, the operating platform 122 has two domains, which are a normal domain NDm and a secured domain SDm. The normal domain NDm and the secured domain SDm are existed concurrently on the operating platform 122 of the mobile device 120.

There are two operating systems (OS) running on the operating platform 122 of the mobile device 120. One of them is a first operating system 124 running within the normal domain NDm. The first operating system 124 is capable of accessing data under the normal domain NDm and denied from accessing data under the secured domain SDm. The other one is a second operating system 126 running within a secured domain. The second operating system 126 is capable of accessing data under both of the normal domain NDm and the secured domain SDm. In one embodiment of the invention, the first operating system can be Android, Windows, Symbian, iOS or any kind of mobile operating system.

In practical applications, the secured domain SDm can be realized with a TrustZone technology developed by ARM company, but the invention is not limited thereto. In embodiemnts of the invention, the secure domain SDm is generally invisible to user from the normal domain NDm and cannot be accessed without proper authorization.

In this embodiment, the operating system 124 can interchange data with the near field communication transceiver 142 via a communication unit 123 of the mobile device 120. In addition, the first operating system 124 can be a general operating system in charge of most basic functions on the mobile device 120 (e.g., phone calling, multimedia playing, system maintaining, user interacting, etc). The normal domain NDm is a public and unprotected domain, which is can be accessed freely and directly by users or applications on the first operating system 124.

The second operating system 126 is mainly in charge of secure payment functions between the mobile device 120 and the payment service provider 140. In this embodiment, the second operating system 126 runs within the secured domain SDm. The secured domain SDm is a private and protected domain, which cannot be accessed nor observed directly by other applications. Generally, the first operating system 124 within the normal domain NDm has no accessibility to the secured domain SDm. After receiving the payment notification from the payment service provider 140, the first operating system 124 can send a request (e.g., a special instruction set designed for communication with the second operating system 126) to trigger the second operating system 126 within the secured domain SDm and access data with the secure domain SDm through a shared memory 128. The shared memory 128 can be a memory space allocated by the kernel system (i.e., the operating platform 122). The shared memory 128 can be allocated in the system memory or other suitable memory device that can be accessed by both of the normal domain NDm and the secured domain SDm. For requests from different applications, the kernel system may allocate individual shared memory space with respect to each of them. The shared memory space can be implemented as a separate region within the memory and the data stored within can be flushed upon completion of corresponding application. Afterward, the second operating system 126 can take over the control of the following payment process. The details of cooperating relationship between the first operating system 124 within the normal domain NDm and the second operating system 126 within the secured domain SDm are disclosed in following paragraphs.

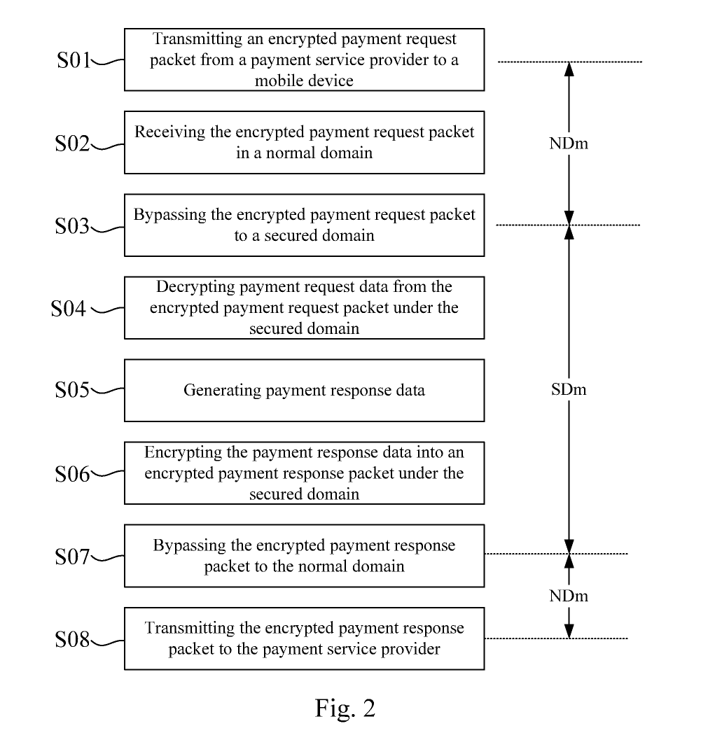

Reference is also made to FIG. 2. FIG. 2 is a flow chart illustrating a secure payment method according to an embodiment of the invention. The secure payment method can be applied on the secure payment system 100 shown in FIG. 1. As shown in FIG. 2, step S01 is executed for transmitting an encrypted payment request packet from the payment service provider 140 to the mobile device 120. The payment request packet can be sent by the near field communication transceiver 142 of the payment service provider 140. The payment request packet is encrypted according to an encryption key. The encryption key is recognized and possessed only by the backend server 144 of the payment service provider 140 and a payment application 125 under the secured domain SDm on the mobile device 120. The encryption key can be generated and comprises specific information related to the mobile device or payment account of the user.

Afterward, step S02 is executed for receiving the encrypted payment request packet by the first operating system 124 running within the normal domain NDm of the mobile device 120. In this embodiment, the encrypted payment request packet can be received by the communication unit 123 at first (as shown in FIG. 1) and then sent to the first operating system 124.

Afterward, step S03 is executed for bypassing the encrypted payment request packet from the first operating system 124 to the second operating system 126 running within the secured domain SDm on the mobile device 120.

In this embodiment, step S03 (bypassing the encrypted payment request packet between the first operating system 124 and the second operating system 126) can be realized by storing the encrypted payment request packet into the shared memory 128, which is accessible to both of the first operating system 124 and the second operating system 126. Therefore, the second operating system 126 may acquire the encrypted payment request packet via the shared memory 128.

Afterward, step S04 is executed for decrypting payment request data from the encrypted payment request packet by the second operating system 126 under the secured domain SDm.

In step S04 of this embodiment, the second operating system 126 may launch the payment application 125 under the secured domain SDm for decrypting the payment request data according to the encryption key. The payment request data may includes information regarding the transaction, for example, bill amount, account identity, payment service provider identity as well as other data relating to the transaction. In addition, the payment request data may includes provider identity information. The provider identity information is verified by payment application 125 under the secured domain SDm before generating payment response data, such that the mobile device 120 may confirm the identity of the payment request source.

Afterward, step S05 is executed for generating payment response data according to the payment request data under the secured domain SDm. In this embodiment, aforesaid payment request data may further includes a client identity verification request. In this case, the payment response data may includes client identity information in response to the client identity verification request. The client identity information can be verified by the payment service provider 140 or a backend server 144 of the payment service provider 140, such that the payment service provider 140 may confirm the user identity of the mobile device 120. For example, the client identity information may include a serial number of the mobile device, a personal identification number or a biometrics characteristic (finger print, face scan, iris recognition, sound recognition, etc) of a user.

Afterward, step S06 is executed for encrypting the payment response data into an encrypted payment response packet under the secured domain SDm. In step S06, the second operating system 126 may launch the payment application 125 under the secured domain SDm for encrypting the payment response data into the encrypted payment response packet according to the encryption key.

It is to be noticed that, the stage from the decrypting step (S04) to the encrypting step (S06) is performed by the payment application 125 and the second operating system 126 under the secured domain SDm, such that the first operating system 124 or any application programs under the normal domain NDm can not acquire the unprotected contents of the payment request data or the payment response data.

Afterward, step S07 is executed for bypassing the encrypted payment response packet from the second operating system 126 to the first operating system 124 under the normal domain NDm. In this stage, the payment response packet is already encrypted and protected by the encryption key only known by the payment application 125 and the payment service provider 140. Therefore, other malicious users or programs may not know the contents within the encrypted payment response packet.

Afterward, step S08 is executed for transmitting the encrypted payment response packet to the payment service provider 140. In this embodiment, the encrypted payment response packet is returned to the near field communication transceiver 142 at first, and then the near field communication transceiver 142 further transmits the encrypted payment response packet to the backend server 144 for processing. The backend server 144 decrypts the encrypted payment data with the encryption key, and verifies the identity of buyer correspondingly. If the identity of the buyer corresponding to the payment is correct, the backend server 144 confirms the payment as successful. If not, backend server 144 denies the payment. In another embodiment, the backend server 144 can return an error message describing the reason of transaction failure to the mobile device 120. Moreover, the backend server 144 can notify the owner of the account corresponding to the payment request by other communication means. For example, the backend server 144 may send a message to the account owner by email or other mobile devices.

In summary, the disclosure provides a secure payment method, a mobile device and a secure payment system. The mobile device is provided with secure payment functionality, and the secure payment package can be transmitted via a near field communication (NFC). The NFC secure payment procedure can be implemented within a private secure operating system (OS) domain. Unlike conventional payment systems, the NFC secure payment procedure of the invention not only can be used for small bill payment, it further provides user authentication, such as personal identification number (PIN) code, finger print even face recognition to provide better protection of transaction. The authentication input is extracted by the mobile device and later encrypted for secure transmission to the payment service provider. The authentication input can also be processed by the mobile device to confirm user identity before the payment is proceeded with the payment service provider.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded with the broadest interpretation so as to encompass all such modifications and similar structures.

What is claimed is:

1. A secure payment method, comprising:
transmitting an encrypted payment request packet from a payment service provider to a mobile device;
receiving the encrypted payment request packet by a first operating system running within a normal domain of the mobile device;
bypassing the encrypted payment request packet from the first operating system to a second operating system running within a secured domain on the mobile device;
decrypting payment request data from the encrypted payment request packet under the secured domain;
generating payment response data according to the payment request data under the secured domain;
encrypting the payment response data into an encrypted payment response packet under the secured domain;
bypassing the encrypted payment response packet from the second operating system to the first operating system under the normal domain; and
transmitting the encrypted payment response packet to the payment service provider.

2. The secure payment method of claim 1, wherein the encrypted payment request packet or the encrypted payment response packet is bypassed between the first operating system and the second operating system in a way of storing the encrypted payment request packet or the encrypted payment response packet into a shared memory, and the shared memory is accessible to both of the first operating system and the second operating system.

3. The secure payment method of claim 1, wherein the first operating system is capable of accessing data under the normal domain and denied from accessing data under the secured domain.

4. The secure payment method of claim 1, wherein the second operating system is capable of accessing data under both of the normal domain and the secured domain.

5. The secure payment method of claim 1, wherein the second operating system launches a payment application under the secured domain for decrypting the payment request data and encrypting the payment response data according to an encryption key.

6. The secure payment method of claim 5, wherein the payment service provider comprise a backend server, the encryption key is recognized and possessed only by the backend server and the payment application under the secured domain.

7. The secure payment method of claim 5, wherein the payment request data comprises provider identity information, and the provider identity information is verified by payment application under the secured domain before generating payment response data.

8. The secure payment method of claim 7, wherein the payment request data further comprises a client identity verification request, the payment response data comprises client identity information in response to the client identity verification request, and the client identity information is verified by the payment service provider or a backend server of the payment service provider.

9. The secure payment method of claim 8, wherein the client identity information comprises a serial number of the mobile device, a personal identification number or a biometrics characteristic of a user.

10. A mobile device, comprising:
an operating platform, the operating platform having a normal domain and a secured domain;
a first operating system running within a normal domain;
a second operating system running within a secured domain;
a communication unit operated by the first operating system under the normal domain, the communication module being used for receiving an encrypted payment request packet from a payment service provider and transmitting an encrypted payment response packet to the payment service provider; and
a shared memory accessible to the first operating system and the second operating system, the encrypted payment request packet and the encrypted payment response packet being bypassed between the first operating system and the second operating system via the shared memory; and
a payment application executed by the second operating system, the payment application being used for decrypting payment request data from the encrypted payment request packet, generating payment response data according to the payment request data and encrypting the payment response data into an encrypted payment response packet under the secured domain.

11. The mobile device of claim 10, wherein the first operating system is capable of accessing data under the normal domain and denied from accessing data under the secured domain.

12. The mobile device of claim 10, wherein the second operating system is capable of accessing data under both of the normal domain and the secured domain.

13. The mobile device of claim 10, wherein the payment application decrypts the payment request data and encrypts the payment response data according to an encryption key.

14. The mobile device of claim 13, wherein the encryption key is recognized and possessed only by a backend server of the payment service provider and the payment application under the secured domain.

15. The mobile device of claim 10, wherein the payment request data comprises provider identity information, and the provider identity information is verified by payment application under the secured domain before generating payment response data.

16. The mobile device of claim 15, wherein the payment request data further comprises a client identity verification request, the payment response data comprises client identity information in response to the client identity verification request, and the client identity information is verified by the payment service provider or a backend server of the payment service provider.

17. The mobile device of claim 16, wherein the client identity information comprises a serial number of the mobile device, a personal identification number or a biometrics characteristic of a user.

18. The mobile device of claim 10, wherein the shared memory is a memory partition allocated in a memory module of the mobile device, and the memory partition is flushed when the payment application is terminated.

19. A secure payment system, comprising:
a mobile device according to claim 10; and
a payment service provider comprising:
a near field communication (NFC) transceiver for transmitting the encrypted payment request packet to the mobile device and receiving the encrypted payment response packet from the mobile device; and
a backend server for generating the encrypted payment request packet toward the mobile device and verifying the encrypted payment response packet feedback from the mobile device.

20. The secure payment system of claim 19, wherein the payment application decrypts the payment request data and encrypts the payment response data according to an encryption key, and the encryption key is recognized and possessed only by the backend server of the payment service provider and the payment application under the secured domain.
